(19) United States
(12) Patent Application Publication
(10) Pub. No.: US 2020/0197136 A1
(43) Pub. Date: Jun. 25, 2020

(54) STENCIL FOR INTRAORAL SURFACE SCANNING

(71) Applicant: TROPHY, Marne La Vallee Cedex 2 (FR)

(72) Inventors: Marianne BELCARI, Croissy-Beaubourg (US); Eamonn BOYLE, Croissy-Beaubourg (US); Jean-Marc INGLESE, Bussy-Saint-Georges (US); Eric VERMELLE, Colombes (US)

(21) Appl. No.: 16/639,987

(22) PCT Filed: Aug. 17, 2017
(86) PCT No.: PCT/IB17/01210

§ 371 Date: Feb. 18, 2020

(51) Int. Cl. A61C 9/00; G01B 11/25; G06T 7/33

(52) U.S. Cl. CPC A61C 9/006; G01B 11/2513; G06T 2207/30036; G06T 2207/10028; G06T 7/33

(57) ABSTRACT

Exemplary method and/or apparatus embodiments for intraoral imaging modify the gums of a patient with indicia, spaced apart over a region of interest. Optical images for surface contour, spanning the region of interest, are acquired, with reflectance images of the region of interest that include the indicia. Exemplary method and/or apparatus embodiments form patch mesh images from the surface contour images, wherein each patch mesh image characterizes the surface contour of a partial portion of the region of interest. The patch mesh images are combined to form a mesh representative of the region of interest according to the plurality of reflectance images of the indicia. The mesh representative of the region of interest can be displayed, stored, or transmitted.

### TECHNICAL FIELD

The disclosure relates generally to the field of intraoral imaging and more particularly relates to a method for improved full-arch scanning for surface characterization of teeth and other intraoral features.

### BACKGROUND

Surface contour imaging uses patterned or structured light and triangulation to obtain surface contour information for an object. In contour imaging, a pattern of lines or other features is projected toward the surface of an object from a given angle. The projected pattern on the surface is then viewed from another angle as a contour image, taking advantage of triangulation in order to analyze surface information and to characterize the surface contour based on the deformed appearance of the projected lines. Phase shifting, in which the projected line pattern is incrementally spatially shifted for obtaining additional measurements at higher resolution, helps to more accurately map the object's surface.

Surface contour imaging using structured light has been employed in a number of applications for determining the shape of solid, highly opaque objects. Contour imaging has also been used for characterizing the surface shape of portions of the anatomy and for obtaining detailed data about skin structure. However, a number of technical obstacles complicate effective use of contour projection imaging of the tooth. Among recognized problems for surface contour imaging of teeth are tooth translucency, high reflection levels, and the complex structure of the teeth itself.

There have been a number of attempts to adapt structured light surface-profiling techniques to the problems of tooth structure imaging. For example, U.S. Pat. No. 5,372,502 entitled “Optical Probe and Method for the Three-Dimensional Surveying of Teeth” to Massen et al. describes the use of an LCD matrix to form patterns of stripes for projection onto the tooth surface. A similar approach is described in U.S. Patent Application Publication 2007/0086762 entitled “Front End for 3-D Imaging Camera” by O'Keefe et al. U.S. Pat. No. 7,312,924 entitled “Polarizing Multiplexer and Methods for Intra-Oral Scanning” to Trissel describes a method for profiling the tooth surface using triangularization and polarized light, but requiring application of a fluorescent coating for operation. Similarly, U.S. Pat. No. 6,885,464 entitled “3-D Camera for Recording Surface Structures, in Particular for Dental Purposes” to Pfeiffer et al. discloses a dental imaging apparatus using triangularization but also requiring the application of an opaque powder to the tooth surface for imaging. U.S. Pat. No. 6,885,464 to Pfeiffer et al. describes an intraoral camera that provides a group of light beams for imaging. Patent application WO 2011/145799 by Lim describes a 3-D scanner using scanned laser light.

One difficulty with scanning using hand-held devices relates to the limited field of view. Typically, the scanner can acquire data from only a small number of teeth at a time. In order to scan a larger portion of the arch, or the full arch, it is necessary to stitch together a number of separate scans, each scan generating a set of surface points or point cloud covering a small portion of the dentition. Registration methods using tooth shapes and evaluating structure features for similarity can be used; however, these methods can be inaccurate, computationally intensive, and slow.

Thus, it can be appreciated that there would be benefits to an optical apparatus and method for intraoral surface contour imaging that facilitates patch-to-patch registration for full arch and other larger span scanning.

### SUMMARY

It is an object of the present invention to advance the art of structured light imaging for intraoral surface contour characterization.

Another aspect of this application is to address, in whole or in part, at least the foregoing and other deficiencies in the related art.

It is another aspect of this application to provide, in whole or in part, at least the advantages described herein.

Among advantages offered by certain exemplary apparatus and/or method embodiments of the application is the capability for improved registration for obtaining large area scans of intraoral features.

These objects are given only by way of illustrative example, and such objects may be exemplary of one or more embodiments of the invention.

Other desirable objectives and advantages inherently achieved by the disclosed methods may occur or become apparent to those skilled in the art. The invention is defined by the appended claims.

According to one aspect of the disclosure, there is provided a method for intraoral imaging comprising:
a) marking the gums of a patient with a plurality of indicia, with the indicia spaced apart over a region of interest;
b) acquiring structured light images for surface contour, spanning the region of interest;
c) acquiring a plurality of reflectance images of the region of interest that include the indicia;
d) forming a plurality of patch mesh images from the surface contour structured light images, wherein each patch mesh image characterizes the surface contour of a partial portion of the region of interest;
e) combining the plurality of patch mesh images to form a mesh representative of the region of interest according to the plurality of reflectance images of the indicia; and
f) displaying, storing, or transmitting the mesh representative of the region of interest.

### BRIEF DESCRIPTION OF THE DRAWINGS

The foregoing and other objects, features, and advantages of the invention will be apparent from the following more particular description of exemplary embodiments of the invention, as illustrated in the accompanying drawings.

The elements of the drawings are not necessarily to scale relative to each other. Some exaggeration may be necessary in order to emphasize basic structural relationships or principles of operation. Some conventional components that would be needed for implementation of the described exemplary embodiments, such as support components used for providing power, for packaging, and for mounting and protecting system optics, for example, are not shown in the drawings in order to simplify description.

FIG. 1 shows an intra-oral imaging apparatus for contour imaging of teeth.

FIG. 2A is a schematic diagram that shows how triangularization is used to obtain surface contour data.

FIG. 2B is a schematic diagram that shows how patterned light is used for obtaining surface contour information.

FIG. 3 is a diagram that shows surface imaging using a pattern with multiple lines of light.

FIG. 4 is a schematic diagram showing how individual scans can be combined to form a larger mesh image.

FIG. 5 shows use of a stencil for indicia marking.

FIGS. 6A, 6B, and 6C show use of a stamp for imprinting a single indicium onto the gum surface.

FIG. 7 shows use of an adhesive tape for providing indicia to support scan registration.

FIG. 8 shows marking the teeth or gums with a printing device.

### DESCRIPTION OF EXEMPLARY EMBODIMENTS

The following is a detailed description of exemplary embodiments, reference being made to the drawings in which the same reference numerals identify the same elements of structure in each of the several figures.

Where they are used in the context of the application, the terms “first”, “second”, and so on, do not necessarily denote any ordinal, sequential, or priority relation, but are simply used to more clearly distinguish one step, element, or set of elements from another, unless specified otherwise.

As used herein, the term “energizable” relates to a device or set of components that perform an indicated function upon receiving power and, optionally, upon receiving an enabling signal.

In the context of the application, the terms “structured light illumination” or “patterned illumination” are used to describe the type of projected illumination that is used for surface imaging, range imaging, or “contour” imaging that characterizes tooth shape. The structured light pattern itself can include, as patterned light features, one or more lines, circles, curves, or other geometric shapes that are distributed over the area that is illuminated and that have a predetermined spatial and temporal frequency. One exemplary type of structured light pattern that is widely used for contour imaging is a pattern of evenly spaced lines of light projected onto the surface of interest.

In the context of the application, the terms “structured light image” and “contour image” are considered to be equivalent and refer to the image that is captured during projection of the light pattern that is used for characterizing the tooth contour. The term “fringe image” can also be used for the structured light image. The term “range image” refers to image content generated using this light pattern that models surface structure. Structured light images are typically taken in a series as a camera is moved along the dental arch. “Adjacent structured light images” are images that are adjacent in the series, with two adjacent structured light images showing a portion of the same image content.

Two lines of light, portions of a line of light, or other features in a pattern of structured illumination can be considered to be substantially “dimensionally uniform” when their line width is the same over the length of the line to within no more than +/−15 percent. As is described in more detail subsequently, dimensional uniformity of the pattern of structured illumination is used to maintain a uniform spatial frequency.

In the context of the application, the term “optics” is used generally to refer to lenses and other types of refractive, diffractive, and reflective components used for shaping a light beam. A light-directing or shaping component in this class is termed an “optic”.

In the context of the application, the terms “viewer”, “operator”, and “user” are considered to be equivalent and refer to the viewing practitioner, technician, or other person who views and manipulates an image, such as a dental image, on a display monitor. An “operator instruction” or “viewer instruction” is obtained from explicit commands entered by the viewer, such as by clicking a button on a camera or by using a computer mouse or by touch screen or keyboard entry.

In the context of the application, the phrase “in signal communication” indicates that two or more devices and/or components are capable of communicating with each other via signals that travel over some type of signal path. Signal communication may be wired or wireless. The signals may be communication, power, data, or energy signals. The signal paths may include physical, electrical, magnetic, electromagnetic, optical, wired, and/or wireless connections between the first device and/or component and second device and/or component. The signal paths may also include additional devices and/or components between the first device and/or component and second device and/or component.

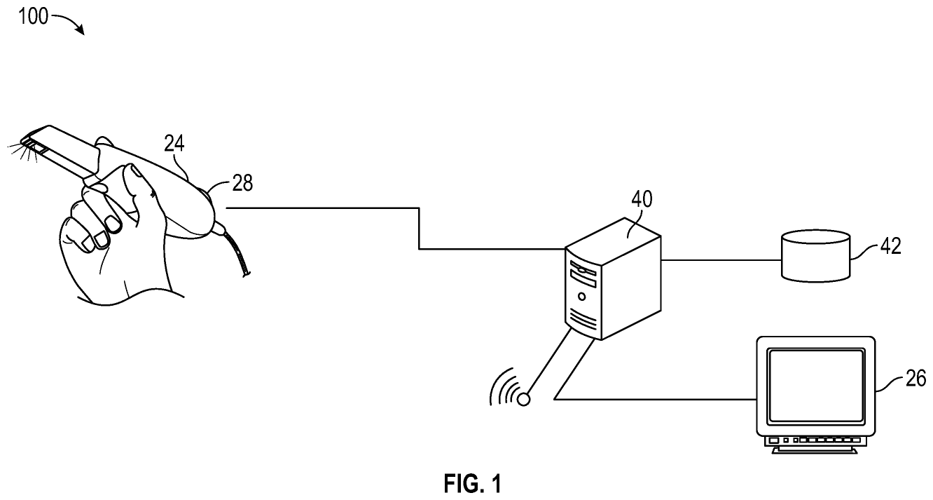

The schematic diagram of FIG. 1 shows an intraoral imaging system 100 having an intraoral camera apparatus 24 that serves as a scanner for projecting structured light onto the surface of the tooth or other intraoral feature. Camera apparatus 24 is in signal communication, over a wired or wireless data communication channel, with a computer 40 that obtains the images from the projected structured light pattern. Computer 40 processes the images and provides output image data that can be stored as a data file and displayed on a display 26. The output image content can show surface contour in the form of a sufficiently dense grouping of surface points or vertices, commonly referred to as a point cloud or mesh. In mesh representation, interconnecting lines may or may not be added to help visually approximate surface structure in display; it is the vertices themselves, however, that are generated as a result of structured light projection, acquisition, and processing using camera apparatus 24.

Computer 40 can be separate from the camera apparatus 24 probe or may be separate from or partially/completely integrated with the probe, such as for providing some portions of the image processing and results reporting described herein. Computer 40 can also store and retrieve image data with a memory 42 that is in signal communication with computer 40, such as in wired or wireless communication along a network. Camera apparatus 24 can have one or more camera elements, along with an audible or visual indicator 28 for device status or for reporting excessive motion.

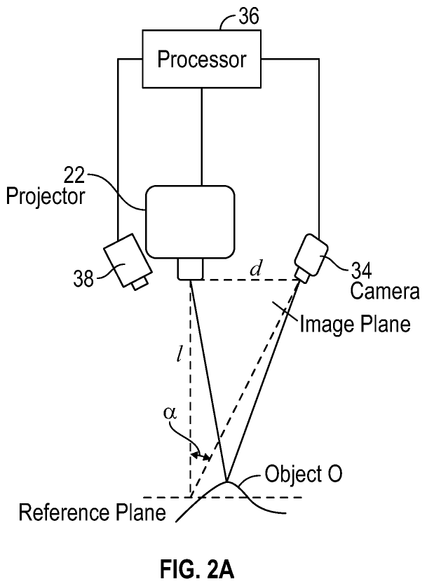

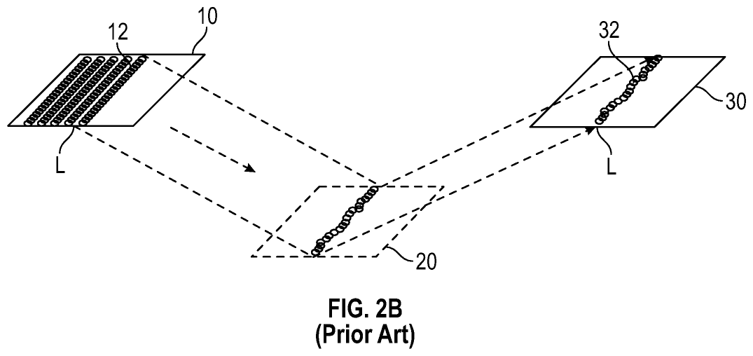

The schematic diagrams of FIG. 2A and 2B show how triangularization is used to obtain surface contour data. Provided within the chassis of camera apparatus 24 shown in FIG. 1, a projector 22 and a camera 34, separated by a distance d, cooperate to scan the surface contour. According to an exemplary embodiment of the application, projector 22 directs successive lines of illumination over a distance 1 onto the object O at a reference plane. Camera 34, at the image plane, acquires image content corresponding to each projected line. A control logic processor 36, such as a computer, dedicated microprocessor, or other logic processing device, synchronizes operation of projector 22 and camera 34 and obtains, stores, and processes or transmits the acquired structured light image data from camera 34 in order to characterize the surface contour of object O. An angle a is representative of the difference in orientation between camera 34 and projector 22. Camera 34 can also have a dual function, used to capture the structured light images and also used to capture a reflectance image using full-field illumination, such as interrupting the structured light projection and acquisition sequence to acquire a reflectance image of the FOV. Another, optional camera 38, typically having a larger field of view (FOV) than the scanning camera 34, can alternately be used to acquire reflectance images that help to register generated patch mesh images according to indicia in the patient's mouth, as described in more detail subsequently.

Exemplary apparatus and/or method embodiments of the application can be of particular value for edentulous patients, or for areas of the mouth where missing teeth can make it difficult for conventional structured light imaging techniques to accurately identify or distinguish different areas of intraoral surfaces and to characterize surface contour. Gum tissue, reddish in hue, tends to absorb blue wavelengths, reducing image contrast and increasing the noise signal content accordingly. Gum surfaces themselves can appear to be highly uniform using structured light imaging, with little change in curvature and with little change in color. It can be difficult to correlate smaller adjacent patch mesh segments to each other, without readily identifiable structures to use as a reference. The existence of multiple implant structures, having similar surface features, can further confound the imaging difficulty.

The schematic diagram of FIG. 2B shows, with the example of a single line of light L, how patterned light is used for obtaining surface contour information. A mapping is obtained as an illumination array 10 directs a pattern of light from projector 22 (FIG. 2A) onto a surface 20 and a corresponding image of a line L' is formed on an imaging sensor array 30 of camera 34. Each pixel 32 (or a plurality of pixels) on imaging sensor array 30 maps to a corresponding pixel 12 on illumination array 10 according to modulation by surface 20. Shifts in pixel position, as represented in FIG. 2B, yield useful information about the contour of surface 20. It can be appreciated that the basic pattern shown in FIG. 2B can be implemented in a number of ways, using a variety of illumination sources and sequences and using one or more different types of sensor arrays 30. Illumination array 10 can utilize any of a number of types of arrays used for light modulation, such as a liquid crystal array or digital micromirror array, such as that provided using a Digital Light Processor (DLP) device, an integrated array of micromirrors from Texas Instruments, Inc., Dallas, Tex.

By projecting and capturing images that show structured light patterns that duplicate the arrangement shown in FIG. 2B multiple times, the image of the contour line on the camera simultaneously locates a number of surface points of the imaged object. This speeds the process of gathering many sample points, while the plane of light (and usually also the receiving camera) is laterally moved in order to “paint” some or all of the exterior surface of the object with the plane of light.

Multiple structured light patterns can be projected and analyzed together for a number of reasons, including to increase the density of lines for additional reconstructed points and to detect and/or correct incompatible line sequences. Use of multiple structured light patterns is described in commonly assigned U.S. Patent Application Publications No. US2013/0120532 and No. US2013/0120533, both entitled “3D INTRAORAL MEASUREMENTS USING OPTICAL MULTILINE METHOD” and incorporated herein in their entirety.

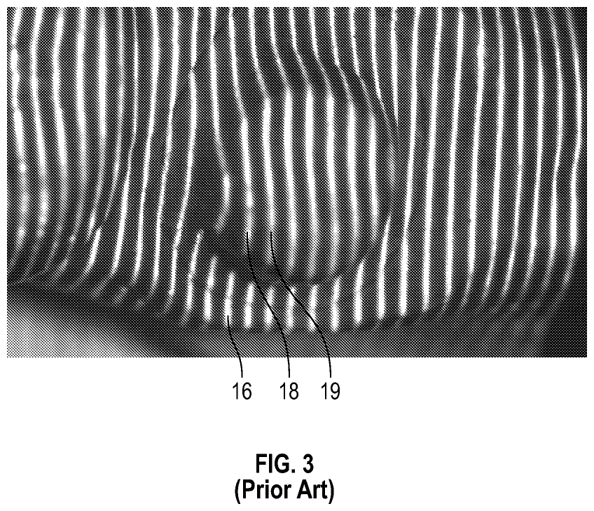

FIG. 3 shows surface imaging using a pattern with multiple lines of light. Incremental shifting of the line pattern and other techniques help to compensate for inaccuracies and confusion that can result from abrupt transitions along the surface, whereby it can be difficult to positively identify the segments that correspond to each projected line. In FIG. 3, for example, it can be difficult over portions of the surface to determine whether line segment 16 is from the same line of illumination as line segment 18 or adjacent line segment 19.

In practice, the structured light sequence that is projected and simultaneously recorded over a field of view (FOV), such as that shown with reference to the example of FIG. 3, is quickly processed in order to generate surface vertex data for that FOV. With movement of the scanner to each successive position in the mouth, the projection, image acquisition, and processing repeats. Each individual vertex mapping for its corresponding FOV provides point cloud or mesh data that must be stitched together with corresponding data from adjacent FOV positions. By stitching together the point cloud or mesh data corresponding to multiple adjacent camera apparatus 24 positions, a patch mesh structure can be formed.

Various types of transforms, familiar to those skilled in surface contour image reconstruction, can be used in order to correctly stitch the individual point cloud or mesh data image content together. One well-known method that can be employed uses point feature histogram (PFH) or fast point feature histogram (FPFH) descriptors for the matching process. By computing FPFH descriptors of two adjacent surface segments, correspondences can be computed, such as using histogram generation and comparison techniques, for example. A RANSAC (Random sample consensus) algorithm can be used to select the largest set of consistent correspondences, providing an initial transform candidate for stitching. More precise alignment can be obtained with iterations, such as using an ICP (iterative closest points) algorithm, accepting or rejecting the placement outcome according to distance or other suitable criterion.

In the context of the application, the mesh structure that is processed and displayed can be constructed from a set of smaller, adjacent mesh portions, stitched together or as a sequence of patches, or “patch mesh” images, each patch mesh image formed as a partial mesh of the dentition for an arch, for combination with other patch mesh structures to form a larger mesh that is representative of the surface contour of the region of interest (ROI). In the context of the application, the structured light image acquired by the scanner and processed by imaging system 100 generates a collection of surface points or vertices, termed a “3D mesh image” or simply “mesh”, also variously termed a 3D “point cloud” or 3D surface contour image.

The field of view (FOV) of intraoral camera apparatus 24 (e.g., handheld) used as a scanner in a typical imaging system 100 is typically no more than about 2 cm². In order to obtain a larger scan, such as a mesh providing a surface scan representation of the full arch or a sizable portion of the arch, multiple sequential scans can be processed, forming a sequence of mesh images in the form of patches, or “patch mesh” images, and the results stitched together to form a larger mesh image. This arrangement also helps to fill in any gaps and to provide surface data to supplement other scan information.

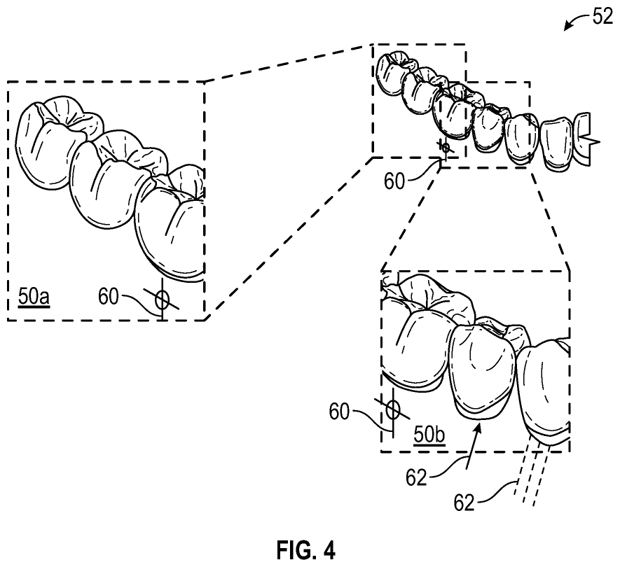

Exemplary apparatus and/or method embodiments according to the application address the need for improved registration of individual scanned patch mesh images, each covering a small area, for forming, by combining these smaller mesh images, a larger or composite mesh image of a larger region of interest (ROI). The simplified schematic diagram of FIG. 4 shows stitching together two smaller patch mesh images 50a and 50b in order to form a larger surface representation or composite mesh image 52. Each of the smaller patch mesh images 50a and 50b includes a registration indicium or marking 60. In order to combine the patch mesh images 50a and 50b to form a portion of larger mesh image 52, the respective indicia in adjacent patch mesh images 50a, 50b are matched, registered, or mapped to each other as shown. In practice, more than a single indicium 60 may typically be needed for proper registration, using the basic principle outlined in the example of FIG. 4.

Indicia 60 can be evenly spaced apart, providing a metric for scanned image combination, both for forming a mesh for a small area or patch and for forming a larger mesh by combining two or more patch mesh images. Alternately, indicia 60 can be spaced apart at arbitrary intervals, sufficiently close to each other to allow image registration, but without the requirement for spacing at equal increments. Indicia density can be a factor affecting accuracy of surface contour reconstruction. Tight spacing between indicia can be useful in some areas of the mouth, such as for edentulous patients, for example.

The indicia shape can be varied in order to reduce ambiguity, in accordance with the scan pattern. Thus, for example, non-symmetric indicia shapes can be advantageous, such as shapes that can be readily distinguished when scanned in any direction, such as the letter “R” for example.

Exemplary apparatus and/or method embodiments according to the application can use the applied indicia not only to help support the stitching process that is used to assemble a patch mesh image from multiple smaller mesh images obtained at different scanner positions, but also to help support subsequent registration of adjacent patch mesh images to each other for providing surface contour results for larger areas of the patient's dental arch.

### Apparatus for Indicia Application

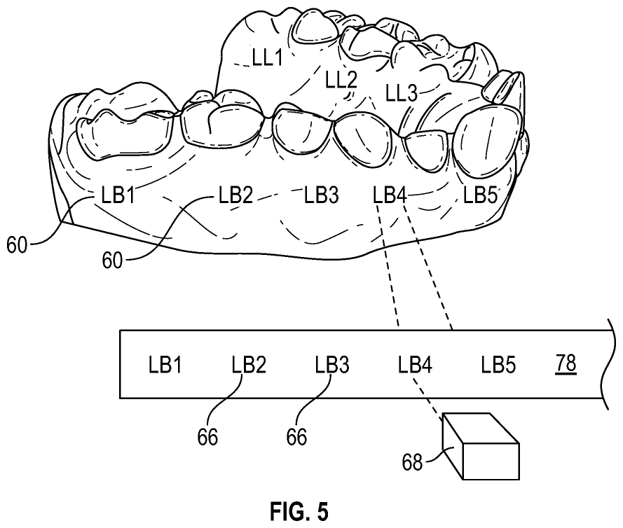

FIGS. 5, 6A-6C, and 7 show various apparatus and/or mechanisms for marking intraoral surfaces according to exemplary embodiments of the application. A stencil 78, as shown in FIG. 5, provides patterns 66 for forming indicia 60 on the tissue surface or dentition. An applicator 68, such as a stamp, squeegee, inkjet, or spray device, directs an ink, dye, pigment, or other colorant through patterns 66 in stencil 78 to form indicia 60 at appropriate locations. Stencil 78 can be arcuate, to extend partially or fully around the dental arch. Alternately, stencil 78 can be flat, designed to extend only a small portion of the gums. Stencil 78 can be formed from a plastic sheet or other flexible material.

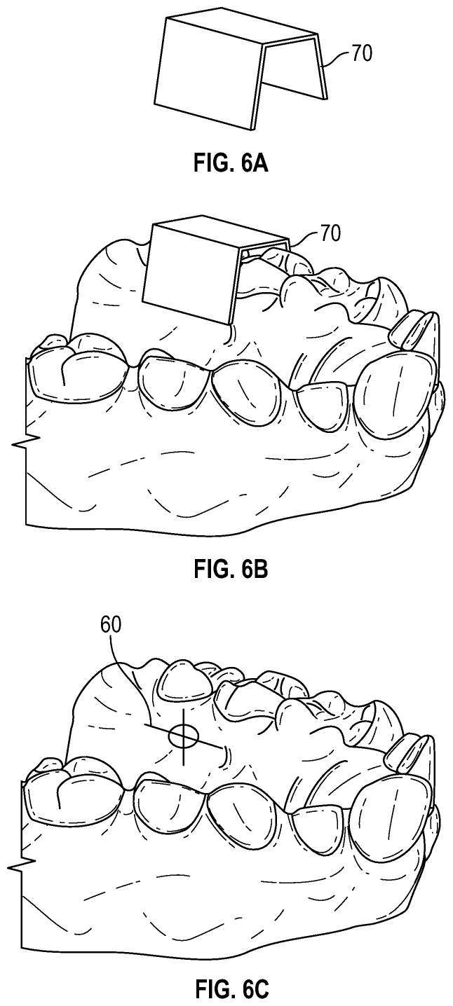

FIGS. 6A, 6B, and 6C show use of a stamp 70 for imprinting a single indicium 60 onto the gum surface. A self-inking applicator or other stamping device is disposed inside a holder, allowing indicia 60 to be formed at suitable points along the arch that is to be scanned. Both buccal or facial outer surfaces and inner or lingual surfaces can be marked at the same time. Stamp 70 can be sized to cover a small portion of an arch, such as a single tooth, or may be formed to mark larger portions or even the full dental arch of a patient at a time.

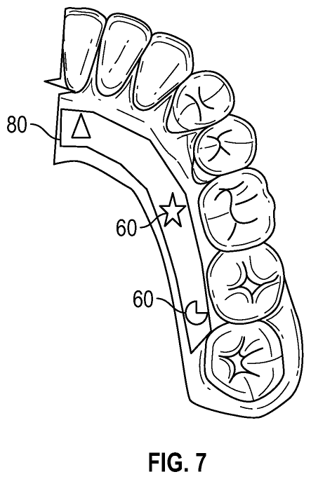

FIG. 7 shows use of an adhesive tape 80 for providing indicia 60 to support scan registration. Tape 80 is formulated to have sufficient adhesion to remain on the gum tissue during imaging, allowing removal after imaging is complete.

Marking directly onto teeth surfaces can alternately be provided, including marking with inks visible only under ultraviolet (UV) light or under other wavelength-specific illumination.

According to one exemplary embodiment of the application, the ink or pigment that is used for the indicia changes the reflectivity of the structured light signal acquired from the intraoral surface. Where reflectivity decreases, data from that portion of the surface can be reduced, leading to incomplete or ambiguous data results, such as “holes” in the detected surface. Where reflectivity increases, there can be a consequent increase in the amount of acquired 3D data over the corresponding portion of the surface. This density variation can be useful for indicia detection and registration, such as when using the PFH or FPFH techniques described previously.

### Indicia Types

As shown in FIGS. 5, 6A-6C, 7, and 8, various types of indicia can be used for scanned patch registration. As described herein, exemplary markings for indicia include but are not intended to be limited to alphanumeric characters, symbols, index or measurement marks, grayscale or color patches, or other symbols (e.g., preferably that can be distinguished from each other) and/or allow patch-to-patch registration.

FIG. 4 shows indicia 62 that indicate orientation axes for teeth or other structures. Orientation axes for individual teeth can be determined in a number of ways, allowing corresponding alignment of indicia for mesh assembly.

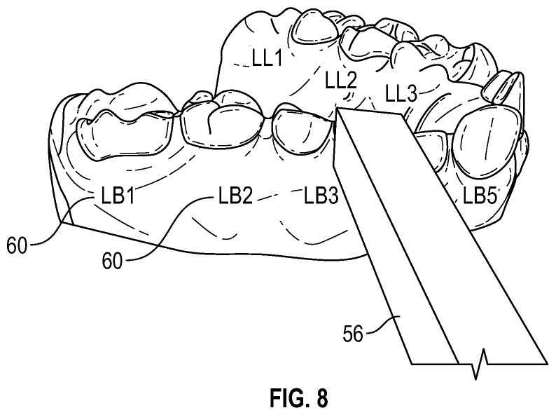

FIG. 8 shows use of a printing device 56 for automatic alignment and application of indicia for patch registration. Printing device 56 can have an arrangement of fittings that seat the device precisely against the tooth for gum marking.

### Imaging Sequence

For alignment processing, the sequence for illumination and image capture can obtain both structured light images over the field of view (FOV), acquired by the scanner, and periodically obtained reflectance images showing a larger camera field of view.

According to another exemplary embodiment of the application, the structured light images acquired by the scanning camera apparatus 24 are processed in order to generate a surface contour or mesh image that is indicative of the scanned intraoral surface. In addition to sensing the structured light pattern that is ordinarily used for surface contour characterization, camera 34 of camera apparatus 24 can also detect indicia 60 on the surface of intraoral structures. Indicia 60 can be used to help guide formation of patch mesh images from the series of structured light images that are acquired, by registering successive structured light images using the indicia, or can be used in subsequent processing stages, with indicia registration as a guide to combining multiple patch mesh images generated after processing the structured light images. Indicia 60 detection may be simultaneous with structured light detection, using camera 34 of FIG. 2A, or may require capture of an intervening reflectance image obtained using full light illumination, such as by temporarily interrupting the series of structured light projections and simultaneous structured light image captures in order to capture a separate reflectance image (using either camera 34 or 38 in FIG. 2A) including the indicia. Alignment of structured light images or of patch mesh images formed from the structured light images and containing the indicia, can be performed in a straightforward manner by registration or mapping of the same indicia in different respective acquired or processed images.

According to another alternate exemplary embodiment of the application, using optional camera 38 (FIG. 2A), one or more alignment reflectance images can be acquired, before, during, or following the scan performed with structured light illumination, wherein the alignment reflectance images can include the marked indicia 60 in the field of view. As in the previously described exemplary embodiment, indicia 60 can be used to help guide formation of individual patch mesh images from the series of structured light images that are acquired, or can be used in subsequent processing stages as a guide to combining multiple patch mesh images, generated after processing the structured light images, in order to form a mesh of larger scale than that of the patch mesh images, as was shown in FIG. 4. Thus, reflectance images can provide the indicia that can be associated with the structured light patterns and that can allow, assist or verify registration of one image patch to the next.

Consistent with at least one exemplary embodiment, exemplary methods/apparatus can use a computer program with stored instructions that perform on image data that is accessed from an electronic memory. As can be appreciated by those skilled in the image processing arts, a computer program of an exemplary embodiment herein can be utilized by a suitable, general-purpose computer system, such as a personal computer or workstation. However, many other types of computer systems can be used to execute the computer program of described exemplary embodiments, including an arrangement of one or networked processors, for example.

A computer program for performing methods of certain exemplary embodiments described herein may be stored in a computer readable storage medium. This medium may comprise, for example; magnetic storage media such as a magnetic disk such as a hard drive or removable device or magnetic tape; optical storage media such as an optical disc, optical tape, or machine readable optical encoding; solid state electronic storage devices such as random access memory (RAM), or read only memory (ROM); or any other physical device or medium employed to store a computer program. Computer programs for performing exemplary methods of described embodiments may also be stored on computer readable storage medium that is connected to the image processor by way of the internet or other network or communication medium. Those skilled in the art will further readily recognize that the equivalent of such a computer program product may also be constructed in hardware.

It should be noted that the term “memory”, equivalent to “computer-accessible memory” in the context of the application, can refer to any type of temporary or more enduring data storage workspace used for storing and operating upon image data and accessible to a computer system, including a database, for example. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Display data, for example, is typically stored in a temporary storage buffer that can be directly associated with a display device and is periodically refreshed as needed in order to provide displayed data. This temporary storage buffer can also be considered to be a memory, as the term is used in the application. Memory is also used as the data workspace for executing and storing intermediate and final results of calculations and other processing. Computer-accessible memory can be volatile, non-volatile, or a hybrid combination of volatile and non-volatile types.

It will be understood that computer program products for exemplary embodiments herein may make use of various image manipulation algorithms and/or processes that are well known. It will be further understood that exemplary computer program product embodiments herein may embody algorithms and/or processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the application, are not specifically shown or described herein and may be selected from such algorithms, systems, hardware, components and elements known in the art.

Exemplary embodiments according to the application can include various features described herein (individually or in combination).

While the invention has been illustrated with respect to one or more implementations, alterations and/or modifications can be made to the illustrated examples without departing from the spirit and scope of the appended claims. In addition, while a particular feature of the invention can have been disclosed with respect to only one of several implementations/exemplary embodiments, such feature can be combined with one or more other features of the other implementations/exemplary embodiments as can be desired and advantageous for any given or particular function. The term “a” or “at least one of” is used to mean one or more of the listed items can be selected. The term “about” indicates that the value listed can be somewhat altered, as long as the alteration does not result in nonconformance of the process or structure to the illustrated exemplary embodiment. Finally, “exemplary” indicates the description is used as an example, rather than implying that it is an ideal. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for intraoral imaging comprising:
a) marking the gums of a patient with a plurality of indicia, with the indicia spaced apart over a region of interest;
b) acquiring structured light images for surface contour, spanning the region of interest;
c) acquiring a plurality of reflectance images of the region of interest that include the indicia;
d) forming a plurality of patch mesh images from the surface contour structured light images, wherein each patch mesh image characterizes the surface contour of a partial portion of the region of interest;
e) combining the plurality of patch mesh images to form a mesh representative of the region of interest according to the plurality of reflectance images of the indicia; and
f) displaying, storing, or transmitting the mesh representative of the region of interest.

2. The method of claim 1, where the structured light images use a pattern of parallel lines.

3. The method of claim 1, where the indicia include at least one of alphanumeric characters and non-alphanumeric characters.

4. The method of claim 1, where the marking is provided on a tape.

5. The method of claim 1, where the marking is provided by a stencil.

6. The method of claim 1, where the marking is provided by a stamp.

7. The method of claim 1, where the marking is provided by an inkjet printing device.

8. The method of claim 1, where one or more of the indicia show an orientation axis for a tooth.

9. The method of claim 8, where combining the plurality of patch mesh images uses registration of detected indicia on the teeth or gums of the patient.

10. The method of claim 8, where combining the plurality of patch mesh images further comprises using indicia for one or more orientation axes.

11. The method of claim 1, further comprising mapping at least one common indicia from the reflectance images to two of the patch mesh images, where the structured light image is a 3D mesh image or a 3D point cloud or a 3D surface contour image.

12. A method for intraoral imaging, comprising:
a) marking one or more intraoral surfaces of a patient with a plurality of printed indicia, spaced apart over a region of interest;
b) illuminating the marked intraoral surfaces with structured light and acquiring a plurality of structured light images of a region of interest within the mouth of the patient, wherein the structured light images include at least portions of the printed indicia;
c) forming a plurality of patch mesh images from the acquired plurality of structured light images;
d) combining the plurality of patch mesh images to form a mesh representative of the region of interest by registering the printed indicia from the patch mesh images; and
e) displaying, storing, or transmitting the mesh representative of the region of interest.

13. The method of claim 12 wherein combining the plurality of patch mesh images to form a mesh uses alignment of indicia showing an orientation axis formed on the patch mesh images.

14. The method of claim 12 wherein the marked intraoral surfaces are gums of the patient.

15. The method of claim 12 wherein the marked intraoral surfaces include teeth.

16. The method of claim 12 wherein the printed indicia are visible only under ultraviolet light.

17. The method of claim 12 wherein forming the plurality of patch mesh images from the acquired plurality of structured light images comprises registering corresponding printed indicia from adjacent structured light images.

18. The method of claim 12, where the marking is provided by a stamp configured to simultaneously mark inner and outer surfaces of a patient's gums.

19. The method of claim 12, where the structured light image is a 3D mesh image or a 3D point cloud or a 3D surface contour image.

20. An apparatus for intraoral imaging, comprising:
a projection system configured to illuminate intraoral surfaces, marked with a plurality of printed indicia, spaced apart over a region of interest with structured light and a detection system configured to acquire a plurality of structured light images of the region of interest within the mouth of the patient, wherein the structured light images include at least some of the plurality of printed indicia;
an image processor configured to form a plurality of patch mesh images from the acquired plurality of structured light images, where the image processor is configured to combine the plurality of patch mesh images to form a mesh representative of the region of interest by registering the printed indicia from the patch mesh images; and
a display configured to display the mesh representative of the region of interest.
